(19) United States
(12) Patent Application Publication
(10) Pub. No.: US 2002/0094816 A1
(43) Pub. Date: Jul. 18, 2002

(54) Method of distributing resources in a telecommunication network and application of the method to call admission

(75) Inventors: Eric Boudjema, Boulogne (FR); Anne Magnier, Paris (FR); Yann Sehedic, Vanves (FR)

Correspondence Address: SUGHRUE MION, PLLC, 2100 Pennsylvania Avenue, NW, Washington, DC, 20037-3213, US

(73) Assignee: ALCATEL

(21) Appl. No.: 09/988,640

(22) Filed: Nov. 20, 2001

(30) Foreign Application Priority Data
Nov. 24, 2000 (FR) 00 15 218

(51) Int. Cl. H04Q 7/20

(52) U.S. Cl. 455/450; 455/451; 455/452

(57) ABSTRACT

In a method of distributing transmission resources in a telecommunication system in which calls from or to terminals pass through a call connection station, the transmission resources controlled by the station are divided into dedicated resources allocated to terminals connected to the station and common resources that can be used by any terminal connected to the station if its dedicated resources are insufficient. This facilitates admitting calls into the network.

### CROSS-REFERENCE TO RELATED APPLICATIONS

This application is based on French Patent Application No. 00 15 218 filed Nov. 24, 2000, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of distributing resources in a telecommunication network. It also relates to application of the method to admitting a call into a network.

1. Description of the Prior Art

To optimize the use of telecommunication networks it is preferable for the networks to transmit a maximum number of calls.

Nevertheless, calls admitted into a network must not in total use more transmission resources than are available in the network.

Otherwise, if the above situation occurs, the network is saturated and does not transmit properly calls already admitted, saturation causing time-delays or interruptions of calls already set up.

The operator determines the frequency and/or risk of saturation and thereby defines network transmission quality.

At present, operators generally use one of the following two operating modes to define the network transmission quality:

In a first operating mode the resources necessary to transmit calls coming from a terminal are permanently dedicated to that terminal.

Thus a particular portion of the resources of the network can be used only for a single terminal, to which those resources are allocated, regardless of the state of activation—transmission state or standby state—of that terminal.

A maximum transmission quality is therefore assured permanently, since the transmission resources necessary to the terminals are permanently available in the network. The resources consist in a frequency or a code, for example.

Nevertheless, this first operating mode is very weak in terms of optimizing the operation of the network, transmission resources being reserved for a terminal even though the latter may not be transmitting calls.

This is why, in a second operating mode, the transmission resources necessary for a call are allocated when the call is admitted into the network and for the duration of the call. In this case whether to accept or reject the call is decided at the time of the call request, before admitting the call into the network, as a function of the transmission resources necessary for that call and the availability of resources in the network.

Thus a call that necessitates a quantity of resources greater than that available in the network is refused.

To this end, the network includes call admission units whose role is to determine whether to admit a new call into the network or to refuse it so that the quality of the incoming call is assured throughout its transmission and the quality of calls already being transmitted is preserved.

This is why the call admission units analyze the parameters of the network (current bit rate, available transmission resources, etc.) and the parameters of the call requesting to be transmitted (bit rate, addressee, transmission resources necessary, etc.) to decide whether to accept the call into the network or to reject it.

The invention starts from the observation that these two prior art methods are unsuitable for some telecommunication networks, in which the characteristics of the calls transmitted by each terminal can vary widely. This applies, for example, if the calls are sent by terminals connected to multimedia stations that can transmit diverse calls (voice, pictures, programs, etc.).

In this case, if the calls sent by terminals are accepted, the quantity of information transmitted subsequently by the terminal is unknown and varies.

This being the case, to assure sufficient transmission quality, it is no longer possible to use a call admission unit operating as previously described, i.e. as a function of the characteristics of the incoming call, because the characteristics of calls transmitted after admitting a terminal into the network are not known.

To solve this problem, the first operating mode mentioned above could be used, but as a general rule the resources of the network are too limited and too costly to reserve resources to each terminal permanently, for example in the case of a satellite telecommunication network.

### SUMMARY OF THE INVENTION

This is why the present invention provides a method of distributing transmission resources in a telecommunication system in which calls from or to terminals pass through a call connection station, in which method the transmission resources controlled by the station are divided into dedicated resources allocated to terminals connected to the station and common resources that can be used by any terminal connected to the station if its dedicated resources are insufficient.

In one embodiment the transmission resources consist in at least one of the following resources: frequencies, powers, time periods, codes.

In one embodiment the dedicated resources are determined using a statistical call model for each terminal over a given time period, the statistical model predicting a theoretical call intensity coming from each terminal at a given time within that period.

Accordingly, using the method according to the invention, it is possible to determine the possibility of accepting a call with a high probability of not saturating the network and in total ignorance of the quantity of resources that the call necessitates. Even if the dedicated resources are insufficient, it is possible to dip into the common resources.

In one embodiment the time period of the model for each terminal is 24 hours.

In one embodiment, for each terminal, at a given time, a call intensity is predicted equal to its maximum call intensity weighted by its habitual rate of use (in Erlangs) at that time.

In one embodiment a call is admitted if the probability of the new call saturating the network is less than a predetermined threshold, where the probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.

The invention also provides a connection station for a telecommunication system in which calls from or to terminals pass through the connection station, which is adapted to distribute resources for transmission from the station to the terminal or from the terminal to the station between dedicated resources that are allocated to terminals connected to the station and common resources that can be used by any terminal connected to the station if its dedicated resources are insufficient.

In one embodiment the resources distributed include at least one of the following resources: frequencies, powers, time periods, codes.

One embodiment of the station is adapted to determine the dedicated resources using a statistical call model for each terminal over a given time period, the statistical model predicting a theoretical call intensity from each terminal at a given time within that period.

This statistical model predicts a theoretical quantity of calls from each terminal at a given time within this period.

In this case the station is adapted to allocate to each terminal at a given time a call intensity equal to its maximum call intensity weighted by its habitual rate of use (in Erlangs) at that time.

In one embodiment the station is adapted to admit calls into the telecommunication system if the probability of the new call saturating the network is less than a predetermined threshold and the probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.

The invention also provides a telecommunication system adapted to distribute transmission resources, in which system calls from or to terminals pass through a connection station, the telecommunication system being adapted to distribute resources for transmission between the station and the terminals between dedicated resources allocated to terminals connected to the station and common resources that can be used by any terminal connected to the station if its dedicated resources are insufficient.

In one embodiment the resources distributed include at least one of the following resources: frequencies, powers, time periods, codes.

In one embodiment distributing resources entails determining the dedicated resources using a statistical call model for each terminal over a given time period, the statistical model predicting a theoretical call intensity from each terminal at a given time within that period.

The system can be adapted to allocate each terminal at a given time a call intensity equal to its maximum call intensity weighted by its habitual rate of use (in Erlangs) at that time.

A call can be admitted if the probability of the new call saturating the network is less than a predetermined threshold and the probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.

Other features and advantages of the invention will become apparent from the following description of embodiments of the invention, which is given by way of non-limiting example and with reference to the accompanying drawings.

### BRIEF DESCRIPTION OF THE DRAWINGS

FIG. 1 is an overview of a telecommunication network.

FIG. 2 is a graphical representation of one way of modeling calls from a terminal.

FIG. 3 is a diagrammatic representation of how the transmission resources of a connection station are used in accordance with the invention.

### DETAILED DESCRIPTION OF THE PREFERRED EMBODIMENT

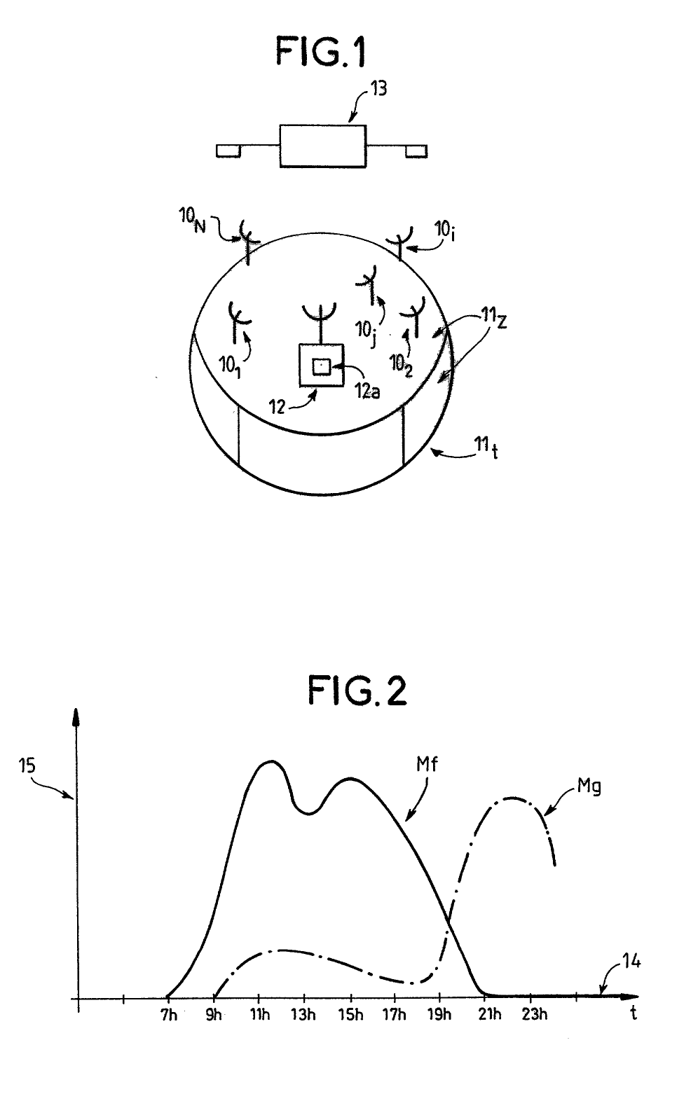

The telecommunication network shown in FIG. 1 uses a constellation of satellites, for example satellites in low or medium Earth orbit, and the Earth 11ₜ is divided into areas 11_{z} within each of which is a connection station 12.

Calls between terminals 10₁, 10₂, 10_{N} in the same area are effected in the following manner: a terminal 10ᵢ first transmits its call to the station 12 via equipment on board a satellite 13, and the station 12 then transmits the call to the destination terminal 10ⱼ, also via the satellite 13.

A call between a terminal 10ᵢ of one area and a terminal of another terrestrial area is effected by setting up a terrestrial or satellite link between the connection stations of the two areas concerned.

It is equally possible to set up a call between a terminal of one area and a terminal of another network using a connection set up between the station 12 and that other network.

In this kind of telecommunication system the transmission resources are limited and are managed by a call admission unit 12ₐ. The embodiment of the invention to be described concerns this type of unit 12ₐ.

If a terminal 10ᵢ must transmit one or more calls via the station 12 and the terminal 10ᵢ is not connected to the station 12, the terminal 10ᵢ calls the station 12 to set up a connection. The call admission unit 12ₐ of the station then decides whether to admit or to reject the call coming from the terminal, as a function of the situation of the transmission resources of the station 12 and the transmission quality demanded by the network operator.

In accordance with the invention, this decision is taken with no knowledge of the exact nature of the calls that the terminal 10ᵢ wishes to transmit.

To this end, the call admission unit 12ₐ initially uses a model of the calls transmitted by each terminal 10₁, 10₂, . . . 10_{N} (see FIG. 2).

FIG. 2 is a diagram in which time in hours is plotted on the abscissa axis 14 and a call intensity, for example a bit rate expressed in kbit/s, is plotted on the ordinate axis 15.

The call model M^{f} of a terminal 10_{f} can be obtained by determining for each hour of the day the most probable value of the call intensity transmitted by the terminal 10_{f}.

That value is preferably obtained by calculating the average of call intensity values previously measured at that time of day for that terminal.

In the FIG. 2 example, the call model M^{f} of the station 10^{f} corresponds to an “office” model with a peak call intensity around 11h00.

A second, “residential”, call model M^{g} transmitted by a terminal 10_{g} is also represented. The second model has consumption peaks different from those of the preceding model: the maximum call intensity occurs during the evening, from 19h30 to 23h00.

As a general rule, any call model Mⁱ of a terminal 10ᵢ is a statistical model. In other words, the predicted call intensity for each terminal 10ᵢ obtained from each model M⁹ is subject to a particular margin of error.

Taking account of this margin of error, the network operator can consider that the call model M^{f} of each terminal 10ᵢ predicts the quantity of calls transmitted after accepting the call request from that terminal.

Knowing the predicted call intensity of a terminal calling the network, the call control unit can refuse or admit a call on the basis of the quality threshold demanded by the operator.

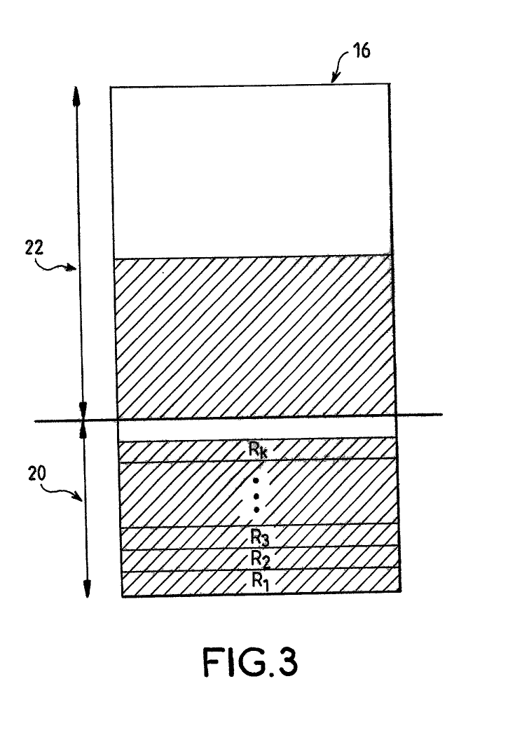

FIG. 3 shows diagrammatically how the invention uses the transmission resource 16 of the station 12 to refuse or admit a call.

This corresponds to application of the invention to uplink transmission, i.e. transmission from a terminal 10ᵢ to the station 12.

In accordance with the invention, the transmission resources 16 of the station 12 are divided into two categories:

A terminal is allocated the resources Rᵢ of the first category, referred to as dedicated resources, when the call from that terminal is admitted into the network. When the dedicated resources are allocated to a terminal in this way, they are reserved exclusively for that terminal, regardless of its call bit rate.

Rather than constituting dedicated resources allocated to one specific terminal, the resources 22 of the second category, referred to as common resources, are pooled and used by any terminal necessitating resources over and above the dedicated resources allocated to it.

In FIG. 3, the dedicated resources Rᵢ allocated to each terminal 10ᵢ are represented in a portion 20.

In this simplified example, the same quantity of dedicated resources R₁, R₂, . . . Rₖ is dedicated to each of the terminals 10₁, 10₂, . . . 10ₖ connected to the station 12. In other words, R₁=R₂=R₃=. . . Rₖ.

To clarify the explanation, it is assumed that the terminals 10₁, 10₂, 10ₖ all necessitate the same quantity of resources by allocating them the same call model, for example of the type M^{f}.

Moreover, using a common resources portion 22 enables the operator to increase the quality of the network, i.e. to reduce the risk of saturation, for a given number of connections.

Indeed, the resources in this portion 22 are common, i.e. they can be used by all the terminals 10₁, 10₂, . . . 10ₖ.

Accordingly, if the transmission dedicated resources Rᵢ allocated to a terminal 10ᵢ are not sufficient for routing calls from that terminal 10ᵢ, the common resources of the portion 22 are used in addition to the dedicated resources Rᵢ allocated to the terminal 10ᵢ.

This use of a common resources portion 22 increases the number of terminals connected without reducing the quality of the network since, statistically speaking, it is not very probable that all the terminals connected to the station 12 simultaneously necessitate a quantity of resources greater than their dedicated resources.

In the simple case of two terminals 10_{f} and 10_{g}, for example, if the terminal 10_{f} is transmitting a quantity of calls that necessitates more resources than the dedicated transmission resources (R_{f}) allocated to it, it is probable that, at the same time, the terminal 10_{g} is transmitting a quantity of calls such that the dedicated transmission resources (R_{g}) that have been allocated to it are sufficient.

In this case, the terminal 10_{f} transmits its call using its dedicated resources R_{f} and resources 22 common to the two terminals, the latter being used only by the terminal 10_{f}.

The advantage of using common resources is then clearly apparent, since it enables each terminal to be allocated dedicated resources less than the transmission resources that are necessary to it when it is transmitting with its maximum call intensity.

Thus the common resources have a buffer function which is used by each terminal when its dedicated resources are insufficient.

However, it may happen that the common transmission resources are not sufficient to alleviate the deficit of dedicated resources of at least one of the terminals 10_{f} and/or 109_{g}. In this case, the network is saturated.

The operator can determine the probability of this situation arising. In accordance with one important aspect of the invention, this probability depends on at least one of the following parameters: the proportion of dedicated resources relative to the overall resources (or the proportion of common resources relative to the overall resources), the number of terminals that are communicating when a new call is requested, the statistical call models of the active terminals, the statistical call models of the terminals requesting to communicate, and the margin of error for each model.

Consequently, knowing the distribution of the transmission resources of the station 12 between a common resources portion 22 and a dedicated resources portion 20, knowing the resources R₁, R₂, . . . Rₖ allocated to each terminal at the time of its connection, and knowing the call models of each terminal 10₁, 10₂, . . . 10ₖ it is possible to determine the probability of saturation of the network at any time.

Accordingly, knowing the parameters previously described and the transmission quality as set by an operator, a call admission unit can determine if a call can be accepted into the network without the risk of saturating the network exceeding the risk accepted by the operator.

Thus, in accordance with the invention, the operator of the station 12 accepts or refuses a call without knowing its actual capacity to assure the required transmission quality.

It must be noted here that by communication resources is meant the carrier frequency and/or a code and/or a time slot and/or a power allocated to a call.

A concrete example of the decision taken by a call admission unit in accordance with the invention is given below, referring to FIG. 3.

In the example, as shown by the indicator 16, the fixed minimum percentage of the common resources portion 22 is approximately two thirds of the total resources of the station 12. In other words, a maximum of one third of the resources 16 of the station 12 of the network is dedicated to one or more terminals.

In the FIG. 3 example, the indicator 16 indicates that the transmission resources of the dedicated resources portion 20 are fully used (approximately 87.5% used) whereas use of the common resources portion 22 is moderate (of the order of 50%).

When terminals want to connect to the station 12, the call admission unit 12ₐ of the station 12 decides to admit or reject the calls as a function of the quality demanded by the operator, i.e. the risk of saturating the network.

To this end, the call admission unit 12ₐ initially considers if it is possible to allocate predetermined dedicated resources to each terminal calling the network.

To simplify the explanation, it is again assumed that all the active terminals are identical and have the same call model. In other words, the same quantity of dedicated resources is allocated to each terminal and thus R₁=R₂=. . . , =Rₖ.

Similarly, a terminal 10ₖ₊₁ calling the station to transmit calls to it is considered to have the same call model as the terminals 10₁, 10₂, . . . , 10ₖ from the time of its call request.

Because k terminals are active and occupy approximately 87.5% of the dedicated resources, it is deduced that each terminal is using 87.5/k% of the resources of the dedicated resources portion 20.

In this case, if k is less than or equal to 6, a new terminal 10ₖ₊₁ cannot receive dedicated resources Rₖ₊₁ identical to those allocated to the other terminals 10₁, 10₂, . . . 10ₖ.

For example, for k=6, each terminal is using approximately 14.6% of the dedicated resources and 87.5% of the resources are already in use; a new terminal cannot be accepted without exceeding the percentage of dedicated resources allocated, causing a risk of network saturation exceeding that set by the operator of the station 12.

On the other hand, if k is greater than or equal to 7, a new terminal can be allocated dedicated resources identical to those of the other terminals.

If k=7, each of them is using 12.5% of the resources of the dedicated resources portion 20. Then a new terminal 10ₖ₊₁ can be allocated dedicated resources Rₖ₊₁ without the dedicated resources portion 20 exceeding the fixed threshold. 100% of the dedicated resources portion 20 is then used.

Indeed, the call admission unit knows the value of k and can determine if it is possible to allocate to the terminal 10ₖ₊₁ the dedicated transmission resources that are allocated to it in a predetermined manner.

If the terminal 10ₖ₊₁ cannot use the dedicated transmission resources that correspond to it in a predetermined manner, the call admission unit refuses to connect the terminal 10ₖ₊₁.

Otherwise, the call admission unit must consider if the common resources are sufficient to transmit the calls already in progress and the call seeking to be connected without violating the probability of saturation set by the network operator.

This consideration is effected by means of statistical models of each terminal based on previous calls.

Indeed, the operator of the station 12 can determine the call models of each terminal 10ᵢ —for example the bit rate used, on average, by each terminal at each time of day - with a given accuracy that is a function of, among other parameters, the number of calls taken into account by the model.

Using this model, the operator can predetermine which resources are necessary to a terminal at a given time of day, with a particular probability related to the use of a statistical model.

Knowing the resources necessary to the connected terminals, with a certain probability, the dedicated resources allocated to the calling terminal, the common transmission resources, and the transmission quality demanded by the operator of the station 12, the call control unit can determine, with a given probability, if admitting a new call conforms to the transmission quality demanded by the operator vis a vis the possible future connection and connections already in progress.

If so, the call is admitted and the connection is set up.

Moreover, although the embodiment described above corresponds to use in the uplink direction, i.e. to a call from a terminal 10ᵢ to the station 12, a variant of the invention can be used for downlink calls, i.e. calls from the station 12 to a terminal 10ᵢ.

Indeed, downlink calls are distinguished from uplink calls in that they are already admitted into the network - they come from the satellite 13.

This being so, the use of dedicated resources allocated to a terminal—that assure the terminal a minimum level of communication with the network—is not necessary and all of the resources of the station 12 are pooled.

However, the unit 12ₐ characterizes each terminal 10_{f} by a provision P_{f} of resources representative, at a given time, of the resources necessary to the terminal 10_{f} on the occasion of downlink calls.

In the preferred embodiment, the provision P_{f} is obtained from call models, for example the FIG. 2 models.

Accordingly, in the event of a downlink call, the call admission unit 12ₐ uses the provisions characteristic of each terminal to evaluate the risk of saturating the network by admitting a call.

In other words, a downlink call is admitted if the probability of saturation of the network by the new call is less than a predetermined threshold, which probability is a function of the following parameters: the proportion of resources allocated relative to the overall resources (or the proportion of common resources relative to the overall resources), the number of terminals that are communicating when a new call is requested, the statistical call models of the active terminals, the statistical call models of the terminals requesting to communicate and the margin of error for each model.

Finally, it should be noted that the present invention can be applied in many types of telecommunication network. In particular, it applies not only to satellite telecommunication networks in which the areas are large, but also to networks in which the areas or cells are smaller, such as mobile telephone networks. In this case, call admission at the level of each cell is not obligatory; it can be commanded at a higher level, for a set of cells.

There is claimed:

1. A method of distributing transmission resources in a telecommunication system in which calls from or to terminals pass through a call connection station, in which method the transmission resources controlled by said station are divided into dedicated resources allocated to terminals connected to said station and common resources that can be used by any terminal connected to said station if its dedicated resources are insufficient.

2. The method claimed in claim 1 wherein said transmission resources consist in at least one of the following resources: frequencies, powers, time periods, codes.

3. The method claimed in claim 1 wherein said dedicated resources are determined using a statistical call model for each terminal over a given time period, said statistical model predicting a theoretical call intensity coming from each terminal at a given time within that period.

4. The method claimed in claim 3 wherein said time period of said model for each terminal is 24 hours.

5. The method claimed in claim 3 wherein, for each terminal, at a given time, a call intensity is predicted equal to its maximum call intensity weighted by its habitual rate of use (in Erlangs) at that time.

6. Application of the method claimed in claim 3 to admitting calls into a telecommunication system into which a call is admitted if the probability of said new call saturating said network is less than a predetermined threshold, where said probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.

7. A connection station for a telecommunication system in which calls from or to terminals pass through said connection station, which is adapted to distribute resources for transmission from said station to said terminal or from said terminal to said station between dedicated resources that are allocated to terminals connected to said station and common resources that can be used by any terminal connected to said station if its dedicated resources are insufficient.

8. The station claimed in claim 7 wherein said resources distributed include at least one of the following resources: frequencies, powers, time periods, codes.

9. The station claimed in claim 7 adapted to determine said dedicated resources using a statistical call model for each terminal over a given time period, said statistical model predicting a theoretical call intensity from each terminal at a given time within that period.

10. The station claimed in claim 7 adapted to allocate to each terminal at a given time a call intensity equal to its maximum call intensity weighted by its habitual rate of use (in Erlangs) at that time.

11. The station claimed in claim 9 adapted to admit calls into said telecommunication system if the probability of the new call saturating said network is less than a predetermined threshold and said probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.

12. A telecommunication system adapted to distribute transmission resources, in which system calls from or to terminals pass through a connection station, said telecommunication system being adapted to distribute resources for transmission between said station and said terminals between dedicated resources allocated to terminals connected to said station and common resources that can be used by any terminal connected to said station if its dedicated resources are insufficient.

13. The system claimed in claim 12 wherein said resources distributed include at least one of the following resources: frequencies, powers, time periods, codes.

14. The system claimed in claim 12 wherein said distribution of resources entails determining said dedicated resources using a statistical call model for each terminal over a given time period, said statistical model predicting a theoretical call intensity from each terminal at a given time within that period.

15. The system claimed in claim 12 adapted to allocate each terminal at a given time a call intensity equal to its maximum call intensity weighted by its habitual rate of use (in Erlangs) at that time.

16. The system claimed in claim 14 wherein a call is admitted if the probability of the new call saturating said network is less than a predetermined threshold and said probability is a function of at least one of the following parameters: the proportion of dedicated resources relative to the overall resources or the proportion of common resources relative to the overall resources, the number of terminals that are communicating when a new call is requested, the statistical call models of the active terminals, the statistical call models of the terminals requesting to communicate, and the margin of error for each model.
